(19) United States
(12) Patent Application Publication
(10) Pub. No.: US 2019/0223092 A1
(43) Pub. Date: Jul. 18, 2019

(54) CONTROLLERS FOR REGULATING ROAMING OF COMMUNICATION DEVICES, AND ASSOCIATED SYSTEMS AND METHODS

(71) Applicant: CABLE TELEVISION LABORATORIES, INC., Louisville, CO (US)

(72) Inventor: Belal Hamzeh, Westminster, CO (US)

(21) Appl. No.: 16/252,394

(22) Filed: Jan. 18, 2019

Related U.S. Application Data
(60) Provisional application No. 62/618,716, filed on Jan. 18, 2018.

(51) Int. Cl. H04W 48/18; H04W 8/12; H04L 29/06; H04W 60/06; H04W 48/16

(52) U.S. Cl. CPC H04W 48/18; H04W 8/12; H04W 48/16; H04W 60/06; H04L 63/0892

(57) ABSTRACT

A method for regulating roaming of at least one user equipment (UE) device among a plurality of wireless communication networks includes (a) obtaining performance information on at least one wireless communication network, (b) updating an available wireless network list on a controller based on the performance information on the at least one wireless communication network, and (c) transmitting the available wireless network list to the at least one UE device.

### RELATED APPLICATIONS

This application claims benefit of priority to U.S. Provisional Patent Application Ser. No. 62/618,716, filed on Jan. 18, 2018, which is incorporated herein by reference.

### BACKGROUND

User equipment (UE) devices, such as mobile phones and tablet computers, are often capable of connecting to two or more wireless communication networks. For example, a UE device may be capable of connecting to either of a mobile phone network or a Wi-Fi network. As another example, a UE device may be capable of connecting to either of two different frequency bands of a mobile phone network.

Wireless network operators frequently try to direct UE devices to connect to a particular wireless network, or a particular type of wireless network, such as to promote low-cost, capacity optimization, and/or network performance. For example, a mobile phone network operator may try to direct UE devices to connect to Wi-Fi networks when such networks are available, to conserve mobile phone network resources, to provide greater bandwidth to UE devices, and/or to minimize mobile phone network roaming charges. As another example, a mobile phone network operator may try to direct UE devices to connect to high-frequency network bands when such bands are available, to promote high network capacity and conservation of low-frequency network bands for applications that require the low-frequency network bands.

### BRIEF DESCRIPTION OF THE DRAWINGS

FIG. 1 is a schematic diagram illustrating a portion of a wireless communication system including a controller for regulating roaming of one or more UE devices among a plurality of wireless communication networks, according to an embodiment.

FIG. 2 is a flow chart illustrating a method for determining performance information of wireless communication networks, according to an embodiment.

FIG. 3 is a flow chart illustrating another method for determining performance information of wireless communication networks, according to an embodiment.

FIG. 4 is a schematic diagram illustrating an available wireless network list, according to an embodiment.

FIG. 5 is a schematic diagram illustrating another available wireless network list, according to an embodiment.

FIG. 6 is a schematic diagram illustrating yet another available wireless network list, according to an embodiment.

FIG. 7 is a schematic diagram illustrating a method for updating available wireless network lists, according to an embodiment.

FIG. 8 is a schematic diagram illustrating a portion of a wireless communication system including a controller configured to receive metrics from UE devices, according to an embodiment.

FIG. 9 is a schematic diagram illustrating a portion of a wireless communication system including a controller configured to receive metrics from wireless access points, according to an embodiment.

FIG. 10 is a schematic diagram illustrating a portion of another wireless communication system, according to an embodiment.

FIG. 11 is a flow chart illustrating a method for regulating roaming of at least one UE device among a plurality of wireless communication networks, according to an embodiment.

### DETAILED DESCRIPTION OF THE EMBODIMENTS

Directing UE devices to connect to particular wireless networks, or to particular types of wireless networks, may achieve significant advantages, such as discussed above. However, problems may occur when these wireless networks provide substandard performance. For example, consider a scenario where a mobile phone network is configured to direct UE devices to connect to Wi-Fi networks when Wi-Fi networks are available, such as to maximize mobile phone network capacity availability. If a given UE device connects to a Wi-Fi network that is congested, a user of the UE device will experience poor UE device operation, which is undesirable for both the user and the network operator. Indeed, the user may elect to disable Wi-Fi operation of the UE device in response to the poor Wi-Fi performance, thereby depriving the user and network operator of potential benefits associated with connecting to high-performing Wi-Fi networks. Thus, blind direction of UE devices to connect to particular wireless networks has significant drawbacks.

Disclosed herein are controllers, methods, and associated systems which regulate roaming of one or more UE devices among a plurality of wireless communication networks. Certain embodiments obtain performance information, e.g., current performance information and/or historical performance information, on at least one wireless communication network. These embodiments update an available wireless network list on a controller based on the performance information and transmit the available wireless network list to the UE devices. The UE devices, in turn, are configured to roam on wireless communication networks in accordance with the available wireless network list. Accordingly, the disclosed embodiments may advantageously prevent UE devices from roaming on underperforming networks, thereby promoting good user experience and consistency with wireless communication network operator performance goals.

In this document, “roam” means to switch connectivity from one wireless communication network to another wireless communication network. For example, a UE device roams from a first wireless communication network to a second wireless communication by disconnecting from the first wireless communication network and connecting to the second wireless communication network. Additionally, in this document, specific instances of an item may be referred to by use of a numeral in parentheses (e.g., UE device 104(1)) while numerals without parentheses refer to any such item (e.g., UE devices 104).

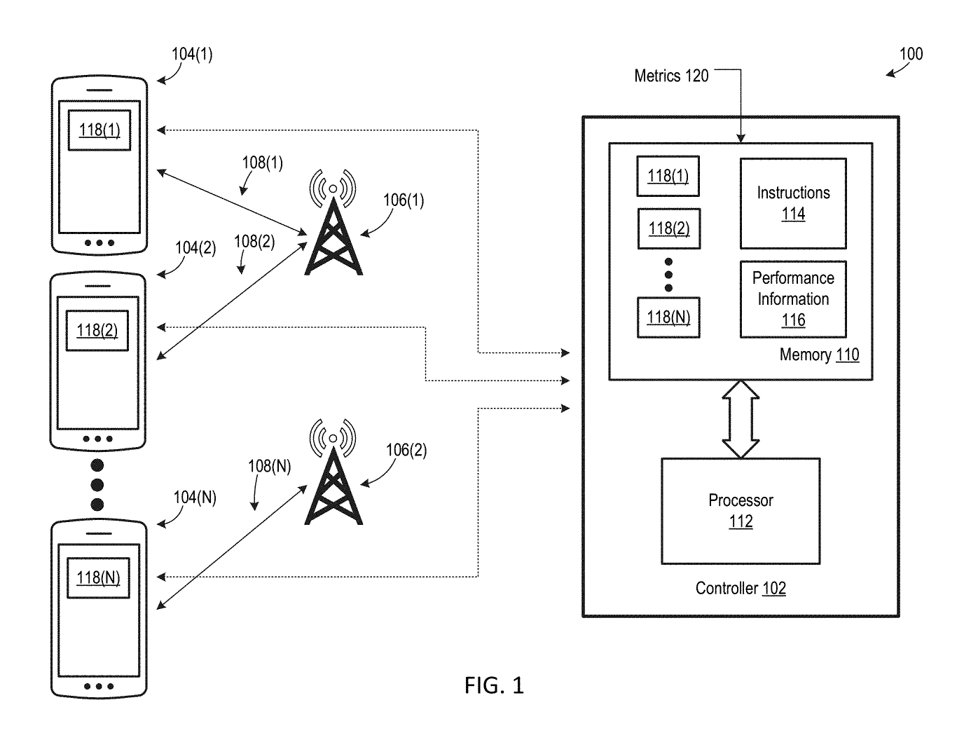

FIG. 1 is a schematic diagram illustrating a portion 100 of a wireless communication system including a controller 102 for controlling roaming N UE devices 104 among a plurality of wireless communication networks 106, where N is an integer greater than or equal to one. Each UE device 104 is, for example and without limitation, a mobile telephone, a laptop computer, a smartwatch, an Internet of Things (IoT) device, a wearable device with wireless capability, a medical device, or a tablet computer. Each UE device 104 may be Subscriber Identity Module (SIM) enabled, Virtual SIM (vSIM) enabled, or non-SIM enabled, such as any variant of a public key infrastructure (PKI) enabled device. All UE devices 104 need not be the same type of UE device. For example, one UE device 104 may be a mobile telephone, and another UE device 104 may be a tablet computer. Additionally, although FIG. 1 shows system portion 100 including at least three UE devices 104, system portion 100 may include only one or two UE devices 104 without departing from the scope hereof.

UE devices 104 wirelessly communicates with one or more wireless communication networks 106 via radio signals 108. Each wireless communication network 106 is, for example and without limitation, a third-generation (3G) wireless communication network, a long-term evolution (LTE) wireless communication network, a fifth-generation (5G) wireless communication network, a sixth-generation (6G) wireless communication network, an IEEE 802.11 (Wi-Fi) wireless network, a Worldwide Interoperability for Microwave Access (WiMAX) wireless communication network, a satellite wireless communication network, or any variations, improvements, and/or evolutions thereof All wireless communication networks 106 need not be the same type of wireless communication network. For example, wireless communication network 106(1) may be a mobile telephone wireless communication network (e.g., 3G, LTE, 5G, or 6G), and wireless communication network 106(2) may be a Wi-Fi wireless communication network or a WiMAX wireless communication network. Additionally, system portion 100 could include additional wireless networks 106 without departing from the scope hereof. Furthermore, although each wireless communication network 106 is symbolically shown as a single element, each wireless communication network 106 may include multiple components disposed at a single location or disposed among multiple locations. For example, in embodiments where wireless communication network 106(1) is a mobile telephone wireless communication network, wireless communication network 106(1) may include multiple base stations and associated supporting equipment. As another example, in embodiments where wireless communication network 106(2) is a Wi-Fi wireless communication network or a WiMAX wireless communication network, wireless communication network 106(2) may include multiple wireless access points and supporting equipment.

FIG. 1 illustrates each of UE devices 104(1) and 104(2) being connected to wireless communication network 106(1) and UE device 104(N) being connected to wireless communication network 106(2). However, connections between UE devices 104 and wireless communication networks 106 may vary, and it is anticipated that UE devices 104 will roam among wireless communication networks 106. For example, UE device 104(2) may roam from wireless communication network 106(1) to wireless communication network 106(2); i.e., UE device 104(2) may disconnect from wireless communication network 106(1) and connect to wireless communication network 106(2). In some embodiments, each UE device 104 is configured to connect to only one wireless communication network 106 at a given time, while in some other embodiments, at least one UE device 104 is configured to connect to two or more wireless communication networks 106 at a given time.

Controller 102 includes at least one memory 110 and at least one processor 112, where at least one processor 112 is communicatively coupled to at least one memory 110. The elements of controller 102 may be disposed at a single location or distributed among multiple locations. For example, in some embodiments, all components of controller 102 are housed in a single chassis, while in some other embodiments, controller 102 includes multiple processors 112 and memories 110 that are housed at multiple different locations, e.g., at different respective data centers. Additionally, while controller 102 is depicted as a stand-alone device, controller 102 is optionally part of a larger device and may share components which the larger device. For example, in certain embodiments, controller 102 is part of a communication network core, including but not limited to a communication network Evolved Packet Core (EPC). From henceforth, at least one memory 110 and at least processor 112 are respectively referred to “memory 110” and “processor 112” for convenience, although it should be appreciated that controller 102 may include a plurality of memories 110 and a plurality of processors 112.

Processor 112 is configured to execute instructions 114 stored in memory 110 to at least (a) obtain performance information 116 on at least one wireless communication network 106, (a) update available wireless network lists 118 on controller 102 based on performance information 116, and (c) transmit available wireless network lists 118 to UE devices 104. In some embodiments, processor 112 performs steps (a) through (c) in response to receiving location information from one or more UE devices 104, such as to update one or more wireless network lists 118 in response to movement of a UE device 104. Instructions 114 are, for example, software and/or firmware. In embodiments where controller 102 includes multiple memories 110, instructions 114, performance information 116, and/or available wireless network lists 118 are optionally spread among two or more memories 110. As discussed below, UE devices 104 roam among wireless communication networks 106 according to wireless network lists 118, such that controller 102 regulates roaming of UE devices 104 by updating available wireless network lists 118.

Processor 112 is configured to execute instructions 114 to obtain performance information 116 from wireless communication network metrics 120. Metrics 120 include, for example but not limitation, one or more UE device 114 locations, congestion level of at least one wireless communication network 106, capacity of at least one wireless communication network 106, bandwidth of at least one wireless communication network 106, latency of at least one wireless communication network 106, and/or coverage of at least one wireless communication network 106. In certain embodiments, performance information 116 is raw data, e.g., the data provided by metrics 120, such as raw congestion, capacity, bandwidth, latency, and/or coverage information. In some other embodiments, processor 112 is configured to execute instructions 114 to analyze at least a portion of metrics 120 to generate performance information 116 that includes processed data. Performance information 116 may include current performance information and/or historical performance information, such as historical network performance patterns, e.g., historical performance patterns of one or more of wireless network congestion, capacity, bandwidth, latency, and/or coverage.

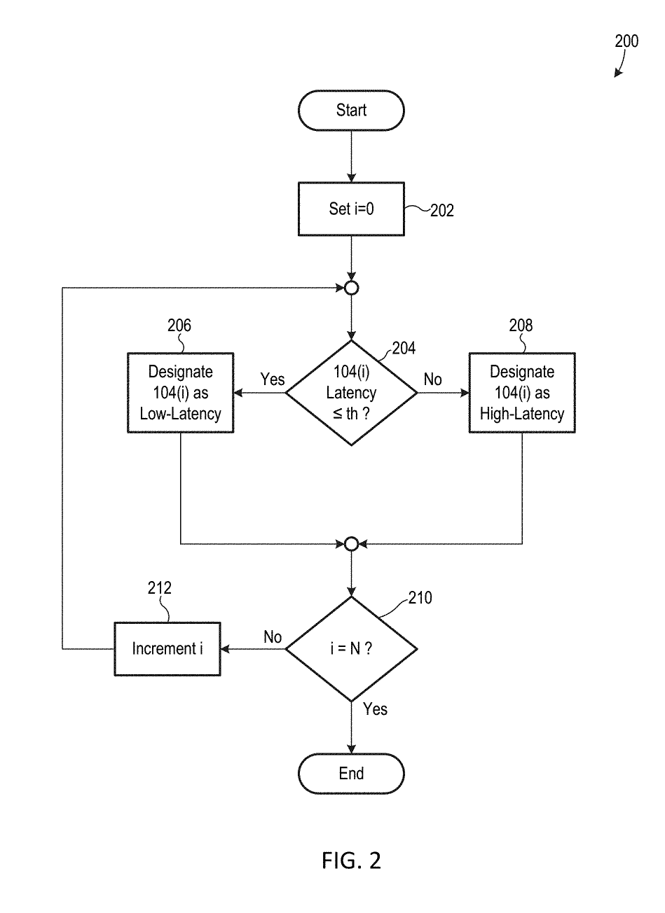

For example, in some embodiments, processor 112 is configured to execute instructions 114 to perform a method 200, illustrated in FIG. 2, to obtain at least some of performance information 116 of wireless communication networks 106. In block 202, processor 112 sets an index (i) to zero. In decision block 204, processor 112 determines if latency of wireless communication network 106(i) is less than a threshold value (th). If yes, processor 112 designates wireless communication network 106(i) as having low-latency in block 206, and if no, processor 112 designates wireless communication network 106(i) as having high-latency in block 208. Processor 112 determines in decision block 210 whether index (i) is equal to N, where N is the number of wireless communication networks 106, as discussed above. If no, processor 112 increments index (i) by one in block 212 and returns to decision block 204; if yes, method 200 ends. Accordingly, processor 112 determines whether each wireless communication network 106 is low-latency or high-latency in method 200, and processor 112 stores such information as performance information 116. Processor 112 optionally periodically performs method 200 and/or performs method 200 in response receipt of location information, or other information, from a UE device 104. In some embodiments, processor 112 uses latency information obtained from executing method 200 multiple times to generate a historical latency pattern which shows, for example, how latency of wireless networks 106 varied over time.

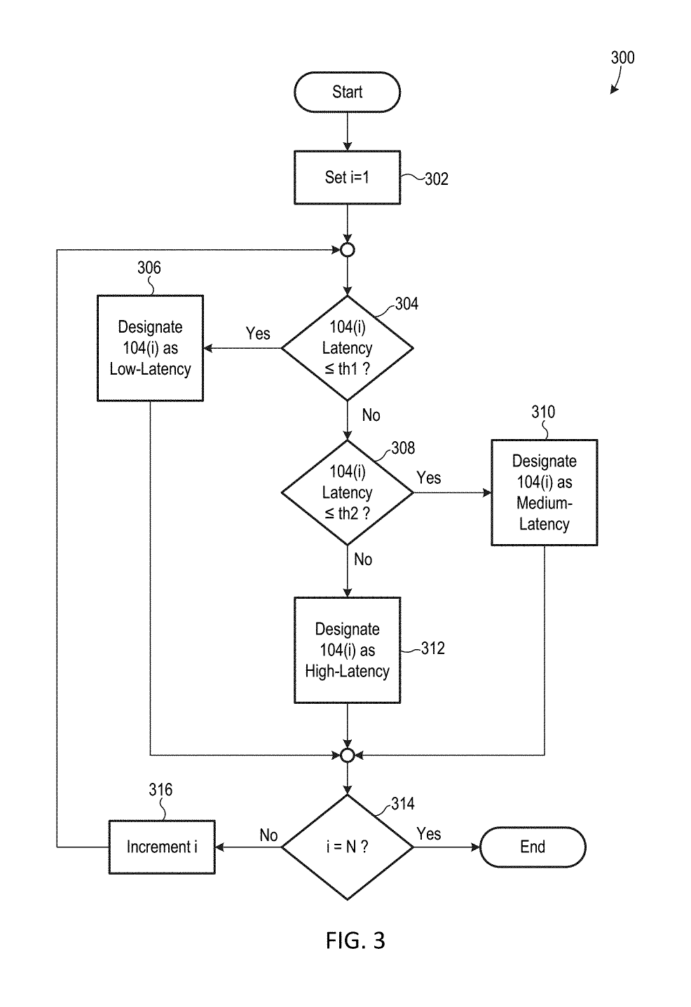

As another example, in some embodiments, processor 112 is configured to execute instructions 114 to perform a method 300, illustrated in FIG. 3, to obtain at least some of performance information 116 of wireless communication networks 106. In block 302, processor 112 sets an index (i) to zero. In decision block 304, processor 112 determines if latency of wireless communication network 106(i) is less than a first threshold value (th1). If yes, processor 112 designates wireless communication network 106(i) as having low-latency in block 306, and processor 306 proceeds to decision block 314. If no, processor 112 proceeds to decision block 308 and determines if latency of wireless communication network 106(i) is less than a second threshold value (th2), where the second threshold value is greater than the first threshold value. If yes, processor 112 designates wireless communication network 106(i) as having medium-latency in block 310, and processor 306 proceeds to decision block 314. If no, processor 112 proceeds to block 312 and designates wireless communication network 106(i) as having high-latency, and processor 112 then proceeds to decision block 314. Processor 112 determines in decision block 314 whether index (i) is equal to N, where N is the number of wireless communication networks 106, as discussed above. If no, processor 112 increments index (i) by one in block 316 and returns to decision block 304; if yes, method 300 ends. Accordingly, processor 112 determines whether each wireless communication network 106 is low-latency, medium-latency, or high-latency in method 300, and processor 112 stores such information as performance information 116. Processor 112 optionally periodically performs method 300 and/or performs method 300 in response receipt of location information, or other information, from a UE device 104. In some embodiments, processor 112 uses latency information obtained from executing method 300 multiple times to generate a historical latency pattern which shows, for example, how latency of wireless networks 106 varies over time.

Either of method 200 or method 300 could be modified to evaluate a different metric of wireless networks 106, e.g., congestion, capacity, bandwidth, or coverage instead of latency, to obtain performance information 116. Additionally, it should be appreciated that controller 102 is not limited to determining performance information according to methods 200 and 300. To the contrary, processor 112 may be configured to execute instructions 114 to evaluate metrics 120 to obtain performance information according to other methods without departing from the scope hereof.

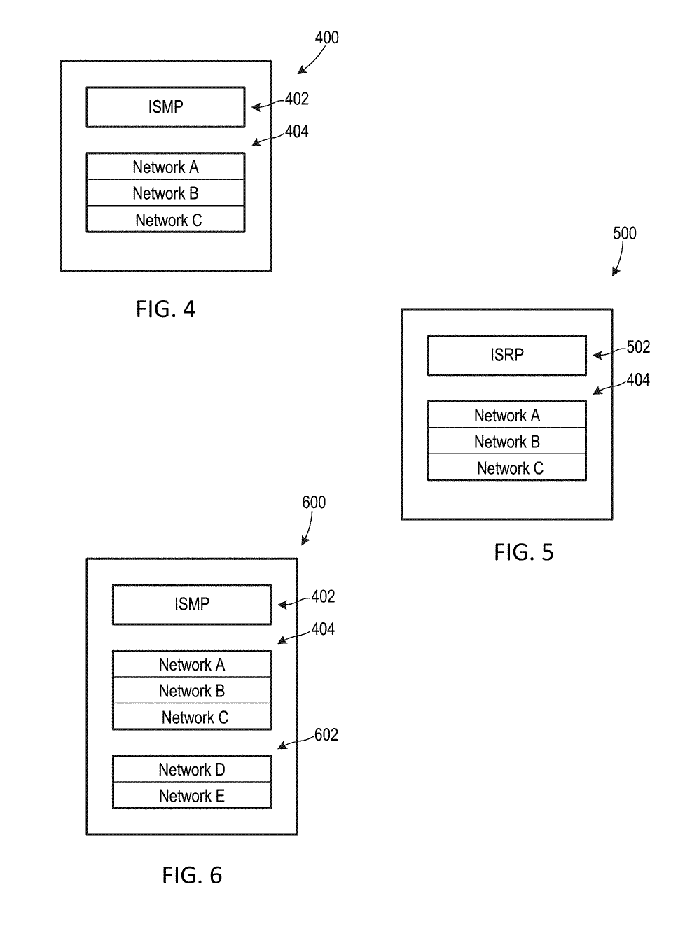

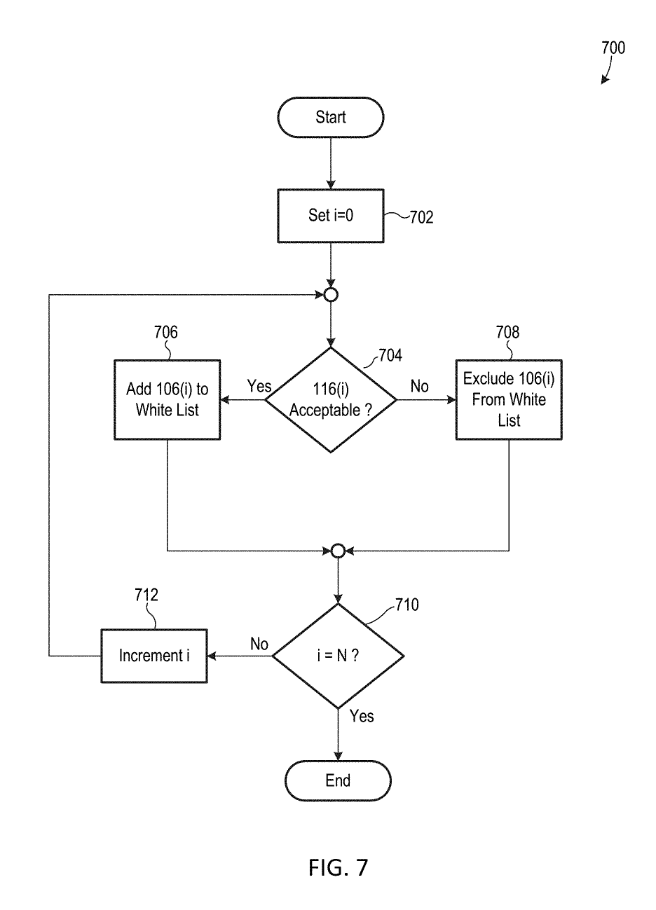

Processor 112 is further configured to execute instructions 114 to update available wireless network lists 118 on controller 102 at least partially based on performance information 116. Each available wireless network list 118 includes a list of available wireless communication networks 106, e.g. a list of wireless communication networks 106 that offer acceptable performance, sometimes referred to as a “white list.” Alternatively or additionally, in some embodiments, each available wireless network list 118 includes a list of unavailable wireless communication networks 106, e.g. wireless communication networks 106 that do not offer acceptable performance, sometimes referred to as a “black list.” In certain embodiments, such as in the example of FIG. 1, processor 112 maintains a respective available wireless network list 118 for each UE device 104. For example, in FIG. 1, processor 112 maintains available wireless network list 118(1) for UE device 104(1), available wireless network list 118(2) for UE device 104(2), and so on. In certain other embodiments, processor 112 maintains less than N available wireless network lists 118, and at least two UE devices 104 share a common available wireless network list 118, such as in cases where two or more UE devices 104 are physically close together. FIGS. 4-6 illustrate several example embodiments of wireless network lists 118. It should be appreciated, though, that available wireless network lists 118 could have other configurations without departing from the scope hereof.

FIG. 4 is a schematic diagram illustrating an available wireless network list 400, which is one embodiment of available wireless network list 118. Available wireless network 400 list includes an inter-system mobility policy (ISMP) 402 and a white list 404. ISMP 402 species rules for selecting wireless communication networks 106 in embodiments where a corresponding UE device 104 cannot have more than one active connection to a wireless communication network 106 at a given time. White list 404 is a list of wireless communication networks 106 in the vicinity of the UE device 104 corresponding to available wireless network list 400 that processor 112 has found to provide acceptable performance based on performance information 116. For example, processor 112 may have determined that the wireless communication networks 106 of white list 404 have acceptable congestion, capacity, bandwidth, latency, and/or coverage. Processor 112 updates white list 404 based on performance information 116, for example, on a periodic basis, in response to a change in performance information 116, and/or in response to a change in location of one or more UE devices 104.

Available wireless network list 400 can include additional information without departing from the scope hereof. Additionally, ISMP 402 can be replaced with a different type of mobility policy, or ISMP 402 can be deleted altogether. For example, FIG. 5 is a schematic diagram illustrating an available wireless network list 500, which is another embodiment of available wireless network list 118. Available wireless network list 500 is similar to available wireless network list 400 but with ISMP 402 replaced with an inter-system routing policy (ISRP) 502. ISRP 502 species rules for selecting wireless communication networks 106 in embodiments where a corresponding UE device 104 can potentially have more than one active connection to a wireless communication network 106 at a given time. Additionally, white list 404 can be replaced with, or supplemented by, another type of wireless communication network 106 list. For example, FIG. 6 is a schematic diagram illustrating an available wireless network list 600, which is yet another embodiment of available wireless network list 118. Available wireless network list 600 is similar to available wireless network list 400 but further includes a black list 602. Black list 602 is a list of wireless communication networks 106 in the vicinity of the UE device 104 corresponding to available wireless network list 600 that processor 112 has found to not provide acceptable performance based on performance information 116. For example, processor 112 may have determined that the wireless communication networks 106 of black list 602 have unacceptable congestion, capacity, bandwidth, latency, and/or coverage.

Referring again to FIG. 1, in some embodiments, processor 112 is further configured to execute instructions 114 to update available wireless network lists 118 according to whether performance information 116 is acceptable or unacceptable for a given wireless network 106. For example, in some embodiments, processor 112 executes instructions 114 to perform a method 700 to update available wireless network lists 118. In block 702 of method 700, processor 112 sets an index (i) to zero. In decision block 704, processor 112 determines if performance information 116(i) of wireless communication network 106(i) is acceptable. Performance information 116(i) is performance information for wireless communication network 106(i), e.g., one or more of congestion, capacity, bandwidth, latency, and/or coverage information for wireless communication network 106(i). In particular embodiments, processor 112 determines if performance information 116(i) of wireless communication network 106(i) is acceptable by comparing performance information 116(i) to one or more thresholds representing acceptable performance. For example, in a particular embodiment, performance information 116(i) includes congestion of wireless communication network 106(i), and processor 112 determines that performance of wireless communication network 106(i) is acceptable if congestion is below a maximum acceptable threshold value.

If the result of decision block 702 is yes, processor 112 adds wireless communication network 106(i) to a white list of available wireless network lists 118, e.g., white list 404 of FIGS. 4-6, and processor 112 proceeds to decision block 710. If the result of decision block 702 is no, processor 112 excludes wireless communication network 106(i) from the white list of available wireless network lists 118, and processor 112 proceeds to decision block 710. In an alternate embodiment of method 700, if the result of decision block 702 is no, processor 112 adds wireless communication network 106i) to a black list of available wireless network lists 118, e.g., black list 602 of FIG. 6. Processor 112 determines in decision block 710 whether index (i) is equal to N. If no, processor 112 increments index (i) by one in block 712 and returns to decision block 704; if yes, method 700 ends. Processor 112 optionally periodically performs method 700 and/or performs method 700 in response receipt of location information, or other information, from a UE device 104.

Referring again to FIG. 1, processor 112 is further configured to execute instructions 114 to transmit each available wireless network list 118 to a respective UE device 104, as symbolically shown by the dashed arrow lines in FIG. 1, e.g., via one or more wireless communication networks 106. For example, processor 112 transmits available wireless network list 118(1) to UE device 104(1), processor 112 transmits available wireless network list 118(2) to UE device 104(2), and so on. However, in embodiments where processor 112 maintains less than N available wireless network lists 118, i.e. where at least two UE devices 104 share a common available wireless network list 118, processor 112 transmits at least one common available wireless network list 118 to two or more UE devices.

Each UE device 104 is configured to roam among wireless communication networks 106 in accordance with its respect available wireless network list 118. For example, in some embodiments, each UE device 104 is configured to roam only among wireless communication networks 106 included a white list, e.g. white list 404 of FIGS. 4-6, of its wireless network list 118. As another example, in some other embodiments, each UE device 104 is permitted to roam among any wireless communication networks 106 that are not included in a black list, e.g., black list 602 of FIG. 6, of its wireless network list 118. Rules regarding roaming for UE devices are specified, for example, in ISMP 402 (FIGS. 4 and 6), ISRP 502 (FIG. 5), or another mobility policy specified in wireless network lists 118 and/or firmware of UE devices 104. A mobility policy specifies, for example, that a UE device can roam among wireless communication networks 106 specified in a wireless network list 118. Thus, controller 102 is configured to regulate roaming of UE devices 104 by updating wireless network lists 118. Accordingly, controller 102 may advantageously help prevent UE devices 104 from connecting to poor-performing wireless communication networks 106, thereby promoting good user experience and consistency with wireless communication network operator performance goals, e.g., to offload UE devices 104 from a first wireless communication network 106 to a second wireless communication network 106 only when the second wireless communication network 106 is high-performing.

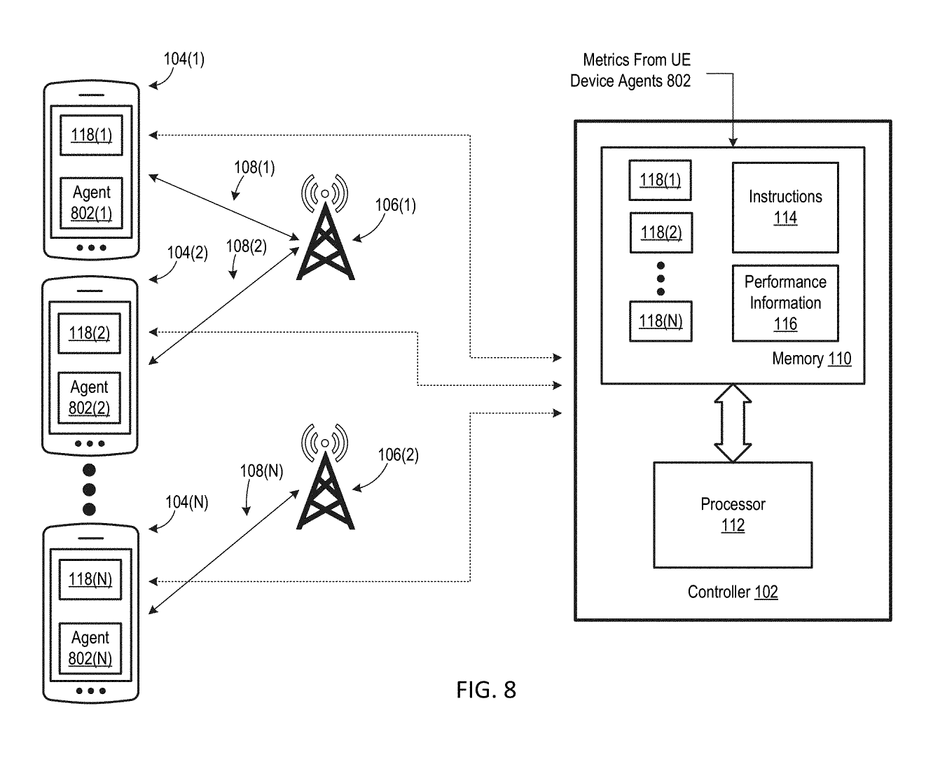

Controller 102 receives metrics 120, for example, from wireless communication devices 104, wireless communication networks 106, and/or another source, e.g., an external monitoring system. For example, FIG. 8 is a schematic diagram illustrating a portion 800 of a wireless communication system where controller 102 is configured to receive metrics 120 from UE devices 104. System portion 800 of FIG. 8 is similar to system portion 100 of FIG. 1 but with each UE device 104 including a respective device agent 802. Each device agent 802 obtains metrics from its respective UE device 104, e.g., one or more of congestion, capacity, bandwidth, latency, and/or coverage for a wireless communication network 106 that the UE device is connected to, and the device agent transmits the metrics to controller 102, e.g., via one or more wireless communication networks 106. Each device agent 802 is implemented by example, by a processor of its respective UE device 104 executing instructions in the form of software and/or firmware storied in a memory of the UE device.

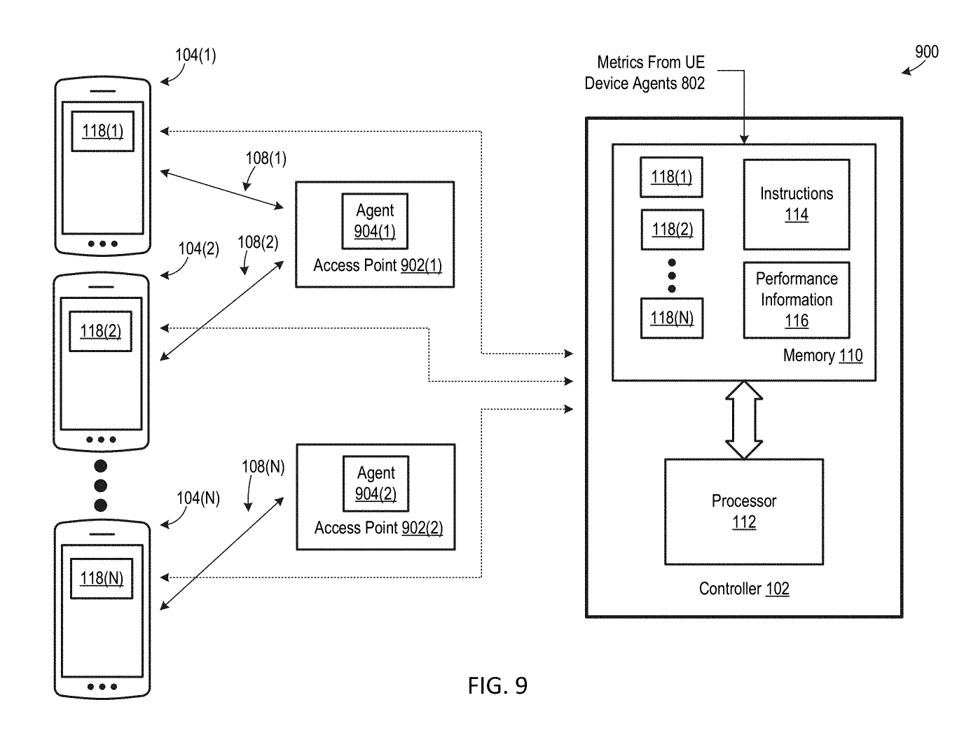

As another example, FIG. 9 is a schematic diagram illustrating a portion 900 of a wireless communication system where controller 102 configured to receive metrics 120 from UE devices 104. System portion 900 of FIG. 9 is similar to system portion 100 of FIG. 1 but with each wireless communication network 106 embodied by a respective wireless access point 902, e.g., a Wi-Fi access wireless access point or a WiMAX wireless access point. Each wireless access point 902 includes a respective access point agent 904. Each access point agent 904 obtains metrics from its respective wireless access point 902, e.g., one or more of congestion, capacity, bandwidth, latency, and/or coverage for the wireless access point 902, and the access point agent transmits the metrics to controller 102. Each access point agent 904 is implemented by example, by a processor of its respective wireless access point 902 executing instructions in the form of software and/or firmware storied in a memory of the wireless access point.

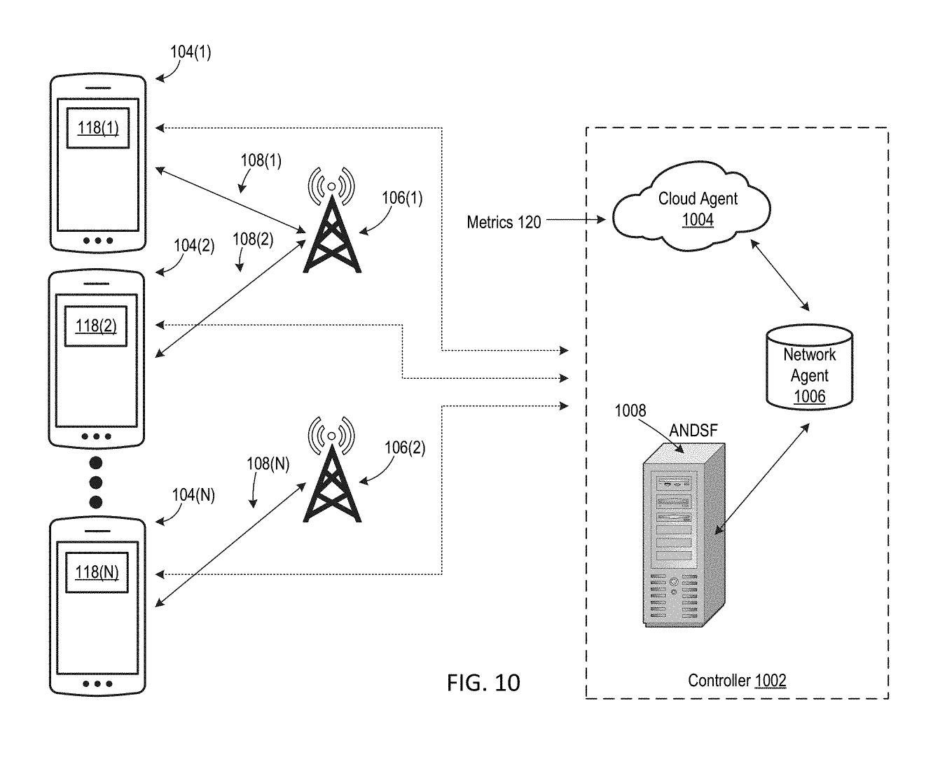

FIG. 10 is a schematic diagram illustrating a portion 1000 of a wireless communication system, which is an embodiment of system portion 100 of FIG. 1 where controller 102 is embodied by controller 1002. Controller 1002 includes a cloud agent 1004, a network agent 1006, and an access network discovery and selection function (ANDSF) server 1008. Cloud agent 1004 receives metrics 120, e.g., from UE devices 104 and/or wireless communication networks 106, and cloud agent 1004 provides performance information 116 (not illustrated in FIG. 10) to network agent 1006. The performance information includes, for example, historical performance patterns of wireless communication networks 106. In some embodiments, cloud agent 1004 is configured to execute either method 200, method 300, or a variation of one of these methods, to provide historical patterns of one or more of congestion, capacity, bandwidth, latency, and/or coverage of wireless communication networks 106. Network agent 1006 updates available wireless network lists 118 (not shown in FIG. 10) on ANDSF server 1008 based on performance information 116. For example, in some embodiments, network agent 1006 executes method 700, or a variation therefore, to update available wireless network lists 118 based on performance information 116. ANDSF server 1008 transmits available wireless network lists 118 to UE devices 104, e.g., via one or more wireless communication networks 106.

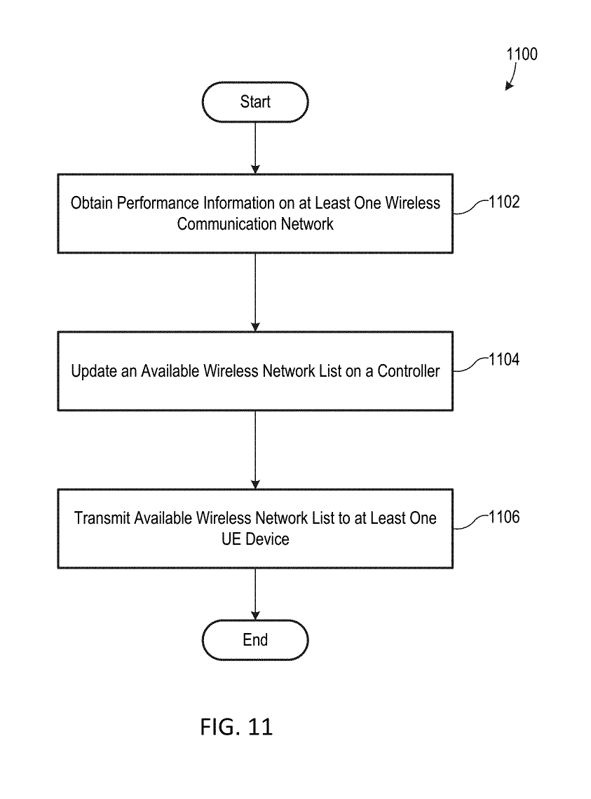

FIG. 11 is flow chart illustrating a method 1100 for regulating roaming of at least one UE device among a plurality of wireless communication networks. In block 1102, performance information on at least one wireless communication network is obtained. In one example of block 1102, processor 112 executes instructions 114 to obtain performance information 116. In block 1104, an available wireless network list on a controller is updated based on the performance information. In one example of block 1104, processor 112 executes instructions 114 to update an available wireless network list 118 based on performance information 116. In block 1106, the available wireless network list is transmitted to at least one UE device. In one example of block 1106, processor 112 executes instructions 114 to transmit the available wireless network list 118 to at least one UE device 104.

### Combinations of Features

Features described above may be combined in various ways without departing from the scope hereof. The following examples illustrate some possible combinations:

(A1) A method for regulating roaming of at least one user equipment (UE) device among a plurality of wireless communication networks may include (1) obtaining performance information on at least one wireless communication network, (2) updating an available wireless network list on a controller based on the performance information on the at least one wireless communication network, and (3) transmitting the available wireless network list to the at least one UE device.

(A2) In the method denoted as (A1), obtaining performance information on the at least one wireless communication network may include obtaining the performance information at least partially from metrics generated by the at least one UE device.

(A3) In the method denoted as (A2), obtaining performance information on the least one wireless communication network further may include generating one or more historical network performance patterns from the metrics generated by the at least one UE device, and updating the available wireless network list on the controller based on the performance information may include updating the available wireless network list at least partially based on the one or more historical network performance patterns.

(A4) In any one of the methods denoted as (A2) and (A3), the metrics generated by the at least one UE device may include one or more of UE device location, congestion level of at least one wireless communication network, capacity of the at least one wireless communication network, bandwidth of the at least one wireless communication network, latency of the at least one wireless communication network, and coverage of the at least one wireless communication network

(A5) In the method denoted as (A1), obtaining performance information on the at least one wireless communication network may include obtaining the performance information at least partially from metrics generated by the at least one wireless communication network.

(A6) In the method denoted as (A5), obtaining performance information on the at least one wireless communication network may include obtaining the performance information at least partially from metrics generated by at least one wireless access point of the at least one wireless communication network.

(A7) In the method denoted as (A6), the at least one wireless access point may include one of a Wi-Fi wireless access point and a WiMAX wireless access point.

(A8) In any one of the methods denoted as (A6) and (A7), obtaining performance information on the at least one wireless communication network may further include generating one or more historical network performance patterns from the metrics generated by the at least one wireless access point, and updating the available wireless network list on the controller based on the performance information may include updating the available wireless network list at least partially based on the one or more historical network performance patterns.

(A9) In any one of the methods denoted as (A1) through (A8), the metrics generated by the at least one wireless access point may include one or more of wireless access point location, congestion on the at least one wireless communication network, capacity of the at least one wireless communication network, bandwidth of the at least one wireless communication network, latency of the at least one wireless communication network, and coverage of the at least one wireless communication network.

(A10) Any one of the methods denoted as (A1) through (A9) may further include enabling a first UE device of the at least one UE device to roam from a first wireless communication network to a second wireless communication network according to the available wireless network list.

(A11) In any one of the methods denoted as (A1) through (A10), a first wireless communication network of the plurality of wireless communication networks may include one of a third-generation (3G) wireless communication network, a long-term evolution (LTE) wireless communication network, a fifth-generation (5G) wireless communication network, and a sixth-generation (6G) wireless communication network, and a second wireless communication network may include one of a Wi-Fi wireless communication network and a WiMAX wireless communication network.

(A12) In any one of the methods denoted as (Al) through (A10), a first wireless communication network of the plurality of wireless communication networks may include a wireless communication network operating within a first wireless frequency band, and a second wireless communication network of the plurality of wireless communication networks may include a wireless communication network operating within a second wireless frequency band that is different from the first frequency band.

(A13) Any one of the methods denoted as (A1) through (A12) may further include obtaining, updating, and transmitting in response to receiving, at the controller, a location of the at least one UE.

(B1) A controller for regulating roaming of at least one user equipment (UE) device among a plurality of wireless communication networks may include at least one memory and at least one processor communicatively coupled to the at least one memory. The at least one processor may be configured to execute instructions stored in the at least one memory to (1) obtain performance information on at least one wireless communication network, (2) update an available wireless network list on the central controller based on the performance information on the at least one wireless communication network, and (3) transmit the available wireless network list to the at least one UE device.

(B2) In the controller denoted as (B1), the at least one processor may be further configured to execute instructions stored in the at least one memory to obtain the performance information at least partially from metrics generated by the at least one UE device.

(B3) In the controller denoted as (B2), the at least one processor may be further configured to execute instructions stored in the at least one memory to (a) generate one or more historical network performance patterns from the metrics generated by the at least one UE device and (b) update the available wireless network list at least partially based on the one or more historical network performance patterns.

(B4) In the controller denoted as (B2), the at least one processor may be further configured to execute instructions stored in the at least one memory to obtain the performance information at least partially from metrics generated by at least one wireless access point.

(B5) In the controller denoted as (B4), the at least one wireless access point may include one of a Wi-Fi wireless access point and a WiMAX wireless access point.

(B6) In either of the controllers denoted as (B4) and (B5), the at least one processor may be further configured to execute instructions stored in the at least one memory to (1) generate one or more historical network performance patterns from the metrics generated by the at least one wireless access point and (2) update the available wireless network list at least partially based on the one or more historical network performance patterns.

(B7) In any one of the controllers denoted as (B1) through (B6), the at least one processor may be further configured to execute instructions stored in the at least one memory to perform the steps of obtaining, updating, and transmitting in response to receiving, at the controller, a location of the at least one UE.

Changes may be made in the above methods, controllers, and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which, as a matter of language, might be said to fall therebetween.

What is claimed is:

1. A method for regulating roaming of at least one user equipment (UE) device among a plurality of wireless communication networks, comprising:
obtaining performance information on at least one wireless communication network;
updating an available wireless network list on a controller based on the performance information on the at least one wireless communication network; and
transmitting the available wireless network list to the at least one UE device.

2. The method of claim 1, wherein obtaining performance information on the at least one wireless communication network comprises obtaining the performance information at least partially from metrics generated by the at least one UE device.

3. The method of claim 2, wherein:
obtaining performance information on the at least one wireless communication network further comprises generating one or more historical network performance patterns from the metrics generated by the at least one UE device; and
updating the available wireless network list on the controller based on the performance information comprises updating the available wireless network list at least partially based on the one or more historical network performance patterns.

4. The method of claim 2, wherein the metrics generated by the at least one UE device comprise one or more of UE device location, congestion level of at least one wireless communication network, capacity of the at least one wireless communication network, bandwidth of the at least one wireless communication network, latency of the at least one wireless communication network, and coverage of the at least one wireless communication network.

5. The method of claim 1, wherein obtaining performance information on the at least one wireless communication network comprises obtaining the performance information at least partially from metrics generated by the at least one wireless communication network.

6. The method of claim 5, wherein obtaining performance information on the at least one wireless communication network comprises obtaining the performance information at least partially from metrics generated by at least one wireless access point of the at least one wireless communication network.

7. The method of claim 6, wherein the at least one wireless access point comprises one of a Wi-Fi wireless access point and a WiMAX wireless access point.

8. The method of claim 6, wherein:
obtaining performance information on the at least one wireless communication network further comprises generating one or more historical network performance patterns from the metrics generated by the at least one wireless access point; and
updating the available wireless network list on the controller based on the performance information comprises updating the available wireless network list at least partially based on the one or more historical network performance patterns.

9. The method of claim 6, wherein the metrics generated by the at least one wireless access point comprise one or more of wireless access point location, congestion on the at least one wireless communication network, capacity of the at least one wireless communication network, bandwidth of the at least one wireless communication network, latency of the at least one wireless communication network, and coverage of the at least one wireless communication network.

10. The method of claim 1, further comprising enabling a first UE device of the at least one UE device to roam from a first wireless communication network to a second wireless communication network according to the available wireless network list.

11. The method of claim 1, wherein:
a first wireless communication network of the plurality of wireless communication networks comprises one of a third-generation (3G) wireless communication network, a long-term evolution (LTE) wireless communication network, a fifth-generation (5G) wireless communication network, and a sixth-generation (6G) wireless communication network; and
the second wireless communication network comprises one of a Wi-Fi wireless communication network and a WiMAX wireless communication network.

12. The method of claim 1, wherein:
a first wireless communication network of the plurality of wireless communication networks comprises a wireless communication network operating within a first wireless frequency band; and
a second wireless communication network of the plurality of wireless communication networks comprises a wireless communication network operating within a second wireless frequency band that is different from the first frequency band.

13. The method of claim 1, further comprising performing the steps of obtaining, updating, and transmitting in response to receiving, at the controller, a location of the at least one UE.

14. A controller for regulating roaming of at least one user equipment (UE) device among a plurality of wireless communication networks, comprising:
at least one memory; and
at least one processor communicatively coupled to the at least one memory, wherein the at least one processor is configured to execute instructions stored in the at least one memory to:
obtain performance information on at least one wireless communication network,
update an available wireless network list on the central controller based on the performance information on the at least one wireless communication network, and
transmit the available wireless network list to the at least one UE device.

15. The controller of claim 14, wherein the at least one processor is further configured to execute instructions stored in the at least one memory to obtain the performance information at least partially from metrics generated by the at least one UE device.

16. The controller of claim 15, wherein the at least one processor is further configured to execute instructions stored in the at least one memory to:
generate one or more historical network performance patterns from the metrics generated by the at least one UE device; and
update the available wireless network list at least partially based on the one or more historical network performance patterns.

17. The controller of claim 14, wherein the at least one processor is further configured to execute instructions stored in the at least one memory to obtain the performance information at least partially from metrics generated by at least one wireless access point.

18. The controller of claim 17, wherein the at least one wireless access point comprises one of a Wi-Fi wireless access point and a WiMAX wireless access point.

19. The controller of claim 17, wherein the at least one processor is further configured to execute instructions stored in the at least one memory to:
generate one or more historical network performance patterns from the metrics generated by the at least one wireless access point; and
update the available wireless network list at least partially based on the one or more historical network performance patterns.

20. The controller of claim 14, wherein the at least one processor is further configured to execute instructions stored in the at least one memory to perform the steps of obtaining, updating, and transmitting in response to receiving, at the controller, a location of the at least one UE.
